(19) United States
(12) Patent Application Publication
(10) Pub. No.: US 2007/0044784 A1
(43) Pub. Date: Mar. 1, 2007

(54) Charcoal briquette lighter accelerator

(76) Inventor: David Alan Thompson, Stanton, CA (US)

Correspondence Address: David Alan Thompson;Unit J, 8440 Cerritos Avenue, Stanton, CA, 90680, US

(21) Appl. No.: 11/211,053

(22) Filed: Aug. 24, 2005

(51) Int. Cl. F24B 3/00; A47J 37/07

(52) U.S. Cl. 126/25 B

(57) ABSTRACT

The invention is a portable electric fire accelerator used for camping and cooking. It has aspects of a fan, switch, motor and the necessary electronic components needed to operate the device. It is designed to operate faster and safer than the methods now being used.

### BACKGROUND OF THE INVENTION

1. Field of the Invention

The present invention relates to a charcoal briquette chimney starter and fire accelerator. The invention introduces a device for use by anyone responsible, wanting to ignite and accelerate the burning properties of paper, wood, charcoal briquettes etc. and in doing so reduce the time needed for their use in cooking, barbequeing, campfires etc.

2. Description of Related Art

A search of prior art did not disclose any patents that read directly on the claims of this instant invention.

### BRIEF SUMMARY OF THE INVENTION

The invention is used to accelerate the burning properties of paper, wood, charcoal briquettes etc. It has aspects of an electric fan and all that is needed to operate the device, electronic switches, batteries, indicator lights and auxiliary jacks for external power sources.

### BRIEF DESCRIPTION OF DRAWINGS

The invention will now be described, by way of example only, with reference to the accompanying drawings, as follows;

FIG. 1. Perspective side view of a preferred embodiment of the present invention.

FIG. 2. Perspective bottom view of a preferred embodiment of the present invention.

FIG. 3. Perspective top view of a preferred embodiment of the present invention.

FIG. 4. Perspective side view of present invention showing how chimney couples to the device and alternate handle placement.

### DESCRIPTION OF THE INVENTION

Detailed descriptions of the preferred embodiments of the present invention are provided herein. It is to be understood, however, that the present invention may be embodied in various forms therefore, specific details disclosed herein are not to be interpreted as limiting, but rather as a basis for the claims and as a representative basis for teaching one skilled in the art to manufacture and employ the present invention in virtually any appropriately detailed system, structure or manner.

### DETAILED DESCRIPTION OF THE INVENTION

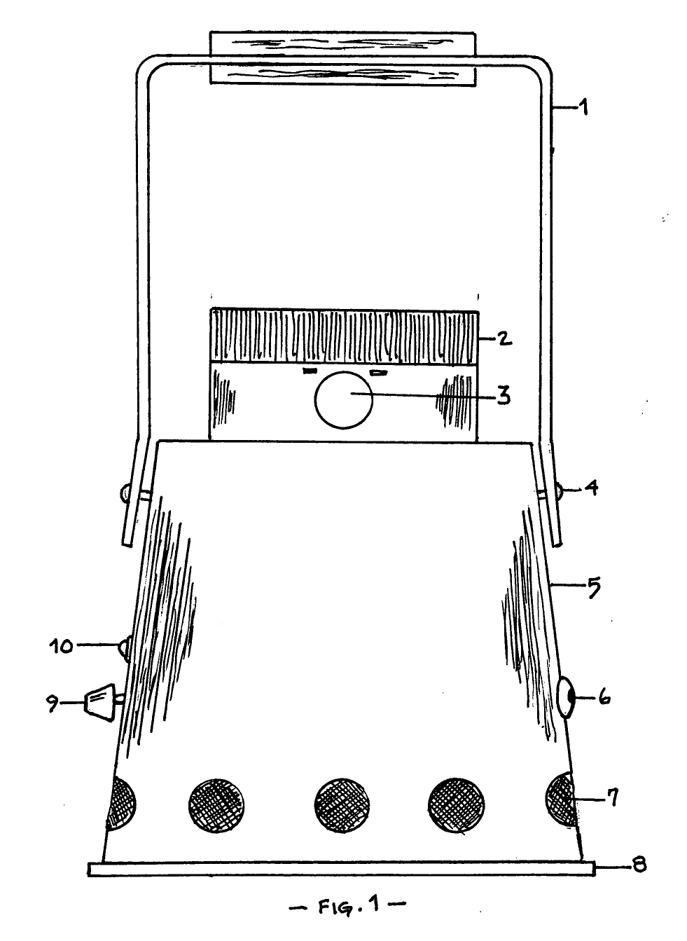

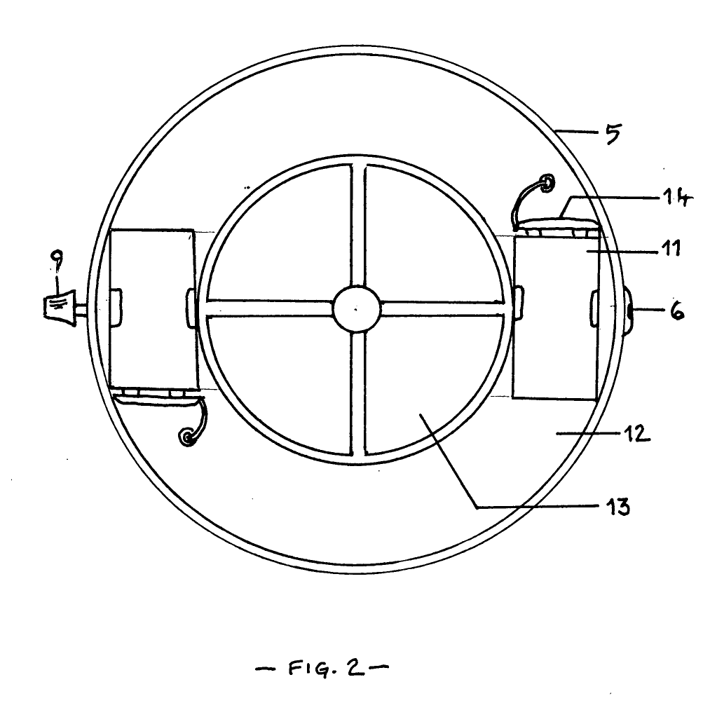

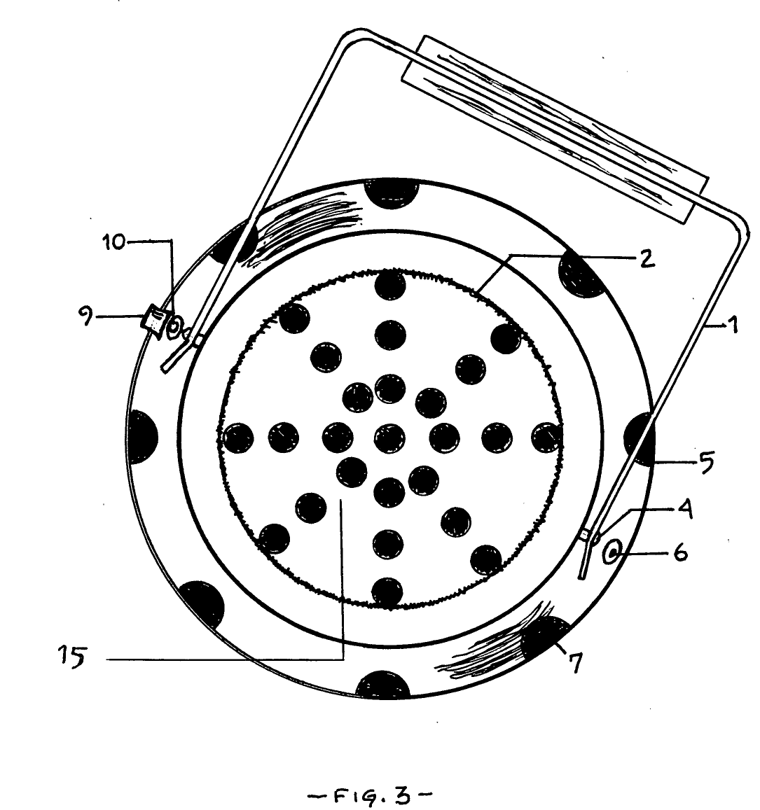

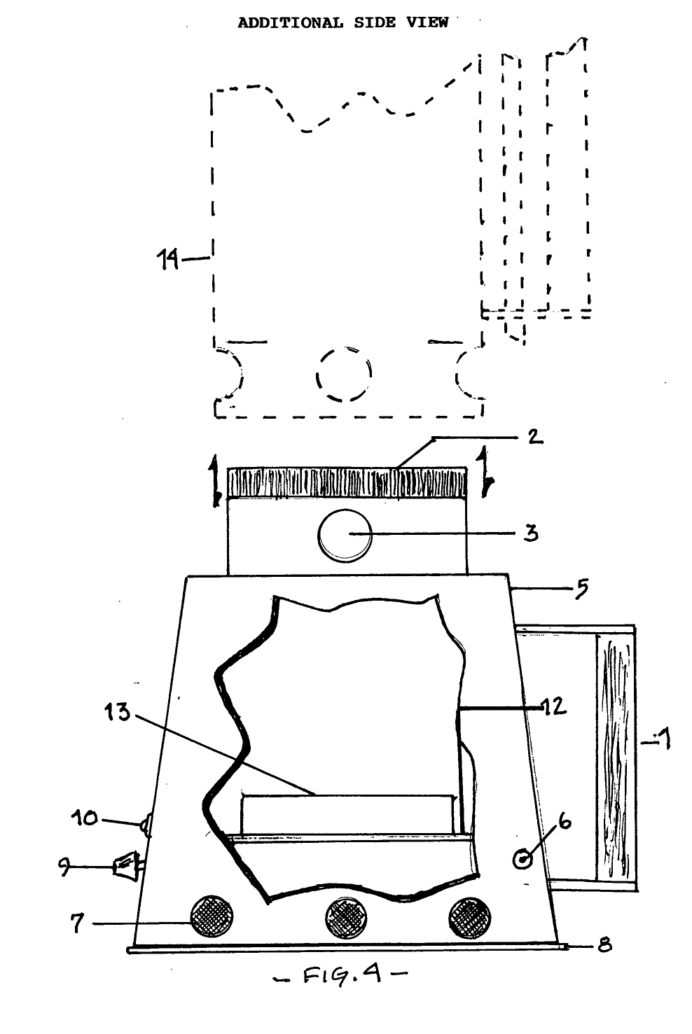

The present invention is a portable device used to ignite wood, paper, briquettes etc. and is designed to accelerate this process. The drawing of FIG. 1. represents a side view of the present invention which can be made of many types of metal and some aspects of it can be made of the right type of plastic. Demonstrated in FIG. 1. is a handle that swivels and has incorporated onto it a wooden section (1). It has an exhaust flue that holds starter paper, wood etc. that when once lighted, and air from the internal fan is activated, this in turn accelerates the burning properties of charcoal briquettes, wood etc. which are located in a chimney starter which has been placed onto and over aforementioned exhaust flue (2). It has a lighting aperture which is used to ignite paper, wood etc. via a match, lighter or other igniting device, this aperture also has incorporated onto it a safety flap which helps to keep any ignited debri from escaping aperture (3). It has rivets which hold handle in place (4). It has a round tapered main body which incorporates within it all the necessary electronic equipment and components needed to operate the device (5). It has an auxiliary jack for use with external power sources (6). It has an LED (light emitting diode) that let the user know the unit is on.(10). It has air intake openings that let the fan draw in air (7). It has a rolled edge at the base for strength and a bottom cover, this bottom can be made removable to gain access to the inner workings of the device (8). It has of course a switch to turn unit on and off (9). The drawing of FIG. 2 represents a bottom view of the present invention. It has batteries to operate the device (11). It has a fan housing (12). It has a fan which can be made of any number of blades and in metal or plastic (13). Attached to this fan is of course an electric motor (not shown). It has battery connectors that connect to the electronics of the device (14). The drawing of FIG. 3 represents a top view of the present invention. Incorporated in FIG. 3 are the same numerical reference characters described in FIG. 1. FIG. 3 also shows air exhaust openings (15) at base of exhaust flue (2). The drawing of FIG. 4 represent an additional side view of the present invention showing how charcoal chimney starter couples to the device and an alternate placement of a fixed handle. (1).

While the present invention has been described in terms of several preferred embodiments, this is not intended to limit the invention to the particular forms set forth, on the contrary, the present invention is intended to cover such alternatives, alterations, modifications, and equivalent structures and devices as may be included within the spirit and scope of the invention as defined within the appended claims.

I claim:

1. A portable electric fire accelerating device, comprising:
a handle;
a main body;
an inner fan and electronic components.

2. The portable electric accelerating device I further comprising an on/off switch.

3. The portable electric accelerating device of claim I further has an LED indicator light.

4. The portable electric accelerating device of claim I further has an auxiliary jack for use with outside power sources.

5. The portable electric accelerating device of claim I further has an electric motor.

6. The portable electric accelerating device of claim I further has a fan with multiple blades.

7. The portable electric accelerating device of claim I further has air intake openings at base of said device.

8. The portable electric accelerating device of claim I further has air exhaust openings at top of said device.

9. The portable electric accelerating device of claim I further has an exhaust flue.

10. The portable electric accelerating device of claim I further has a lighting aperture.

11. The portable electric accelerating device of claim I further has a safety flap at said aperture.

12. The portable electric accelerating device of claim I further has a fixed handle attached to main body of device.

13. The portable electric accelerating device of claim I further has a wooden section incorporated onto said handle.

14. The portable electric accelerating device of claim I further has a main body which is circular and tapered.

15. The portable electric accelerating device of claim I further has a removable bottom at base of unit.
